(19) United States
(12) Patent Application Publication
(10) Pub. No.: US 2003/0009601 A1
(43) Pub. Date: Jan. 9, 2003

(54) Program execution method in an environment of a plurality of computers

(76) Inventor: Kunihisa Nitta, Zama (JP)

Correspondence Address: Mattingly, Stanger & Malur, P.C., 104 East Hume Avenue, Alexandria, VA, 22301, US

(21) Appl. No.: 10/167,690

(22) Filed: Jun. 13, 2002

(30) Foreign Application Priority Data
Jun. 20, 2001 (JP) 2001-185848

(51) Int. Cl. G06F 15/163; G06F 9/00; G06F 9/54

(52) U.S. Cl. 709/310

(57) ABSTRACT

An program execution method in a multi-computer environment composed of a plurality of computers is disclosed. In this method, a program which is dependent on at least one of the computers can be executed with the computer being transparent to the user. In each execution environment definition file, software information defining the execution environment needed by the respective program is stored. In a software definition table, software information defining the execution environment of each computer is stored. The execution environment selecting unit acquires corresponding software information by referring to the execution environment definition file prepared for the program to be executed and selects a computer which has a software information containing the acquired software information by referring to the software definition table. The execution requesting unit requests the selected computer to execute the program and the program execution unit of the requested computer executes the program.

### BACKGROUND OF THE INVENTION

The present invention relates to a program execution method in a multi-computer environment comprising a plurality of computers in which programs are dependent on the environments of some of the computers.

As known, in a distributed system comprising a plurality of computers interconnected via a network or the like, processing functions are distributed to among the plurality of computers and processing is performed by having these computers cooperate with each other. One of such systems is a client server system in which processing is driven through program-to-program message exchanges between the client side and the server side as described in “Internetworking with TCP/IP vol. 1—Principles, Protocols, and Architecture” 2.sup.nd Edition, written by Douglas Corner, translated by Jun Murai and Hiroyuki Kusumoto, published by KYORITSU SHUPPAN CO., Ltd., P241-P247.

Another method is to automatically select a computer for execution from a plurality of computers. One of the methods of selecting a computer for execution is disclosed in, for example, Japanese Patent Laid-open No. 10-334057 entitled “DYNAMIC LOAD DISPERSION PROCESSING METHOD OF BATCH JOB AND SYSTEM THEREFOR IN DISPERSION SYSTEM ENVIRONMENT”. In this method, a computer is selected for execution according to the resource utilization characteristics in each computer, such as CPU utilization rate, memory utilization rate and I/O utilization rate.

In the client server model cited above, however, programs must be placed on both client and server sides. Therefore, since a client must be aware of which server has objective programs thereon, this model requires troublesome work in the development and management of programs.

In the load dispersed processing method, a computer is selected for a job merely according to the situation of use of the resources to be used for the job. Therefore, this method cannot be applied to a system composed of a plurality of computers which differ in architecture, operating system and available software if the programs to be executed are respectively dependent on the execution environments of some computers. For a computer-dependent program, it is necessary to select a computer having an execution environment that suffices the program.

### SUMMARY OF THE INVENTION

An object of the present invention is to provide a method of executing such a computer-dependent program with a computer that executes the program being transparent to the user when executing the program.

According to one aspect of the present invention, there is provided a method for executing a program in a multi-computer environment composed of a plurality of computers where the program is dependent on at least one of the computers. The method comprises the steps of referring to a first storage means where software information defining the execution environment needed to execute respective program is stored, and acquiring corresponding software information; by referring to a second storage means where software information defining an execution environment of each computer is stored, selecting a computer which has a software information containing the acquired software information; and requesting the selected computer to execute the program for execution, and executing the program for execution by the selected computer.

Further, according to another aspect of the present invention, there is provided a program execution method in a multi-computer environment composed of a plurality of computers. The method comprises the steps of registering an identifier of the executed program to a third storage means in association with an identifier of the computer selected for the program; referring to the third storage means to know the identifier of the program for execution has already been registered there in association with the identifier of a computer before acquiring the software information, and if the identifier has been registered, requesting the registered computer to execute the program.

The present invention allows the user to treat a multi-computer system like a single-computer system in the development and management of programs.

### BRIEF DESCRIPTION OF THE DRAWINGS

FIG. 1 is a configuration diagram of a computing system composed of a plurality of computers according to an embodiment of the present invention;

FIG. 2 is a diagram indicating contents of a software definition table 140 according to the embodiment;

FIG. 3 is a diagram indicating contents of a program definition table 150 according to the embodiment;

FIG. 4 is a diagram indicating an example of association of programs with file systems in an execution environment definition file;

FIG. 5 is a diagram indicating contents of execution environment definition files 132 according to the embodiment;

FIG. 6 is a flowchart of assistance in explaining the operation of an execution environment selecting unit 111 and an execution-requesting unit 112 when a program is executed in the embodiment;

FIG. 7 is a flowchart of assistance in explaining the operation of a program execution unit 113 in the embodiment; and

FIG. 8 is a flowchart of assistance in explaining the operation of the execution environment-selecting unit 111 and the execution-requesting unit 112 when no corresponding execution environment definition file has been defined in the embodiment.

### DETAILED DESCRIPTION OF THE INVENTION

A preferred embodiment of the present invention will be hereinafter described with reference to the drawings.

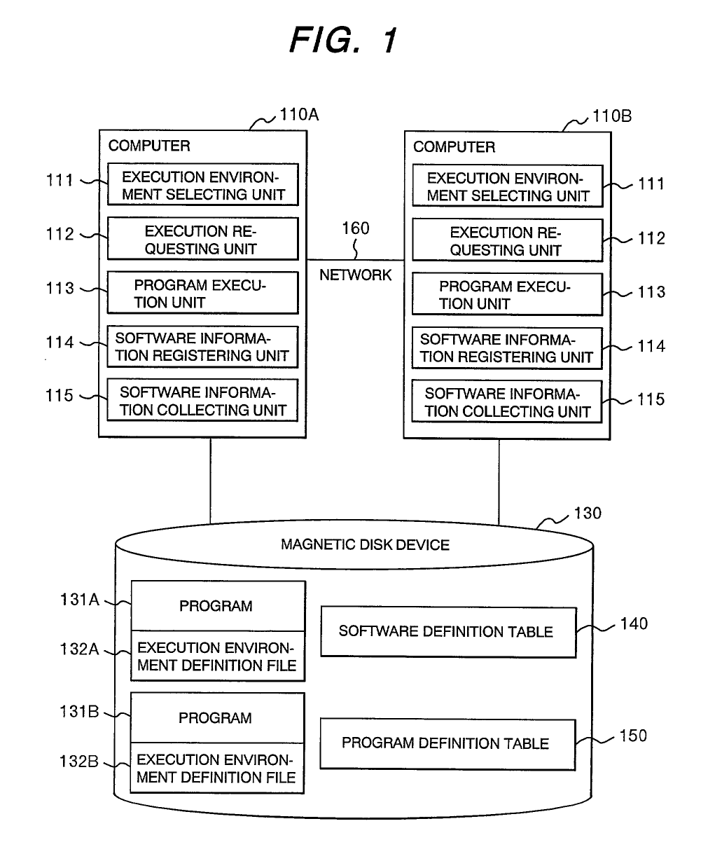

FIG. 1 is a diagram indicating a system configuration according to an embodiment of the present invention. The system includes a computer 110A, a computer 110B, a network 160 to connect both the computers, and a magnetic disk device 130 connected to and shared by both the computers. The computers 110A and 110B each store programs for an execution environment selecting unit 111, an execution requesting unit 112, a program execution unit 113, a software information registering unit 114 and a software information collecting unit 115 in the respective memories and the programs are executed by the processor of the computer.

Shared by the computer 110A and the computer 110B, the magnetic disk device 130 contains a program 131a prepared by the computer 110A, a program 131B prepared by the computer 110B, an execution environment definition file 132A associated with the program 131A, an execution environment definition file 132B associated with the program 131B, a software definition table 140 and a program definition table 150. Note that when one of the computers 110A and 110B is referred to in the following, it is denoted as computer 110 in some case. Similar denotations “program 131” and “execution environment definition file 132” are also used.

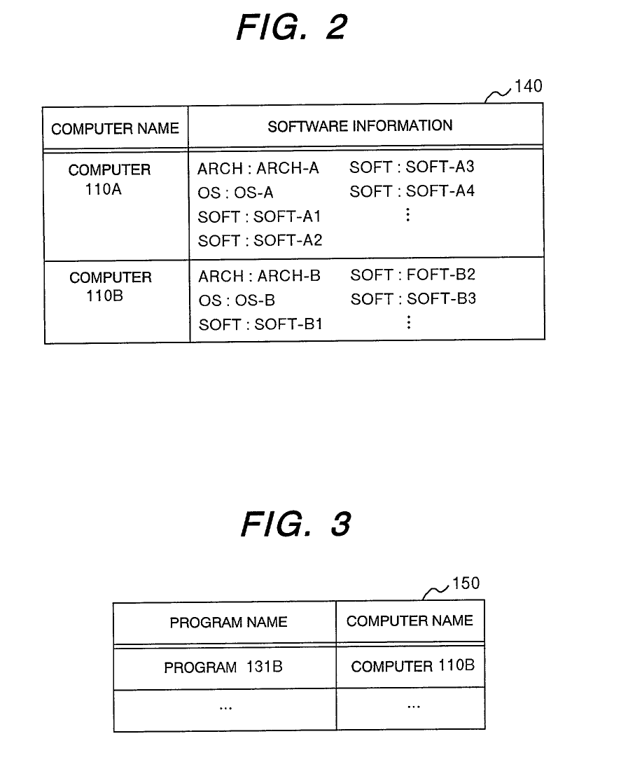

Shown in FIG. 2 is an example of software information stored in the software definition table 140. In this example, it is defined that the computer 110A employs ARCH-A as the architecture and OS-A as the operating system and has SOFT-A1, SOFT-A2, etc. as available software and that the computer 110B employs ARCH-B as the architecture and OS-B as the operating system and has SOFT-B1, SOFT-B2, etc. as available software. Note that each software shown there is given a convenient name, and practically, consists of one or more programs. The software definition table 140 provides information about the whole program execution environment of each computer.

FIG. 3 indicates the data configuration of the program definition table 150. Each entry of the program definition table 150 indicates an association of a program name (identifier) with the computer name of a computer capable of executing that program. For example, an entry indicates that the program 131B can be executed in the execution environment of the computer 110B as shown in the figure.

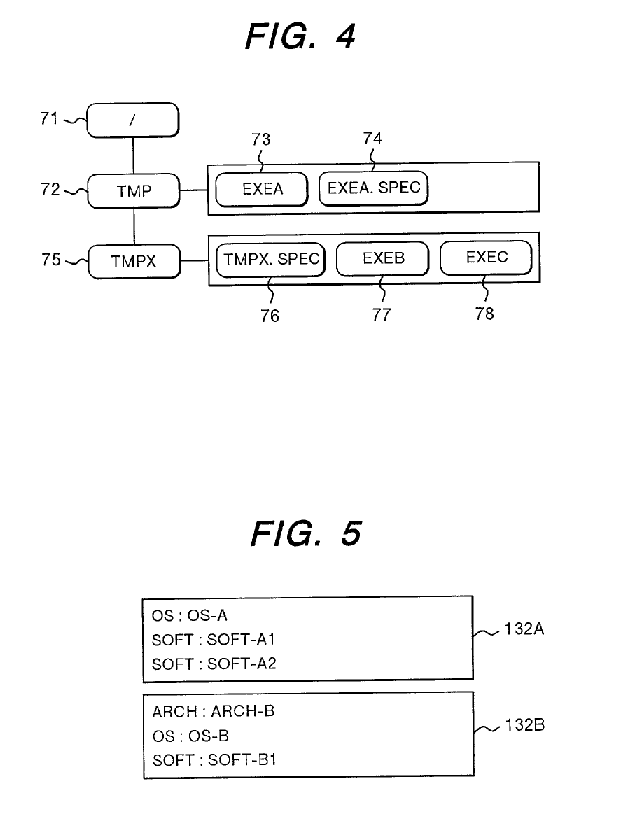

FIG. 4 is a diagram of assistance in explaining an example of the association of a program with an execution environment file in an ordinary hierarchical file system. In this example, a directory TMP 72 exists under a root (/) 71 and a program EXEA 73, an execution environment definition file EXEA.SPEC 74 and a directory TMPX 75 exist under the directory TMP 72. The TMPX 75 has an execution environment definition file TMPX.SPEC 76, a program EXEB 77, and a program EXEC 78. The EXEA 73, the EXEB 77 and the EXEC 78 are executable files in a binary or script form. In this example, each program is associated with the corresponding execution environment definition file by means of naming. The name of each execution environment definition file starts with the name of the corresponding program or directory, followed by a word SPEC for differentiation. That is, the EXEA.SPEC 74 is an execution environment definition file for the program EXEA 73 while the TMPX.SPEC 76 is an execution environment definition file for the directory TMPX 75. These execution environment definition files are text format files. An execution environment definition file, if its name includes the name of a directory, is associated with all files which exist in the directory. That is, the program EXEB 77 and the program EXEC 78 both under the TMPX 75 are executable in the same execution environment, which is defined in the execution environment definition file TMPX.SPEC 76. In this method, execution environment definition files can be set up through a smaller amount of work. Needless to say, the directories and files for execution environment definition must be accessible from the execution environment-selecting unit 111 of either computer 110.

FIG. 5 indicates an example of information stored in the execution environment definition files 132A and 132B. Defined in the execution environment definition file 132A is that the operating system OS-A and the software SOFT-A1 and SOFT-A2, a subset of the software information of the computer 110A, are required to execute the program 131A. It is also defined that the program 131A does not depend on either architecture. Similarly, it is defined in the execution environment definition file 132B that the program 131B cannot be executed without the architecture ARCH-B, the operating system OS-B and the software SOFT-B1, a subset of the software information of the computer 110B.

The software information-collecting unit 115 of each computer collects software information about that computer. Information about the architecture and operating system can be obtained from the information table held by the operating system while information about the available software can be obtained from an installation information file. The installation information file is a file for the management of information about the installed software and is created and updated by an installation program (installer) used for installation. Each software information-registering unit 114 registers the collected software information to the software definition table 140 when that computer is initially connected to the magnetic disk device 130.

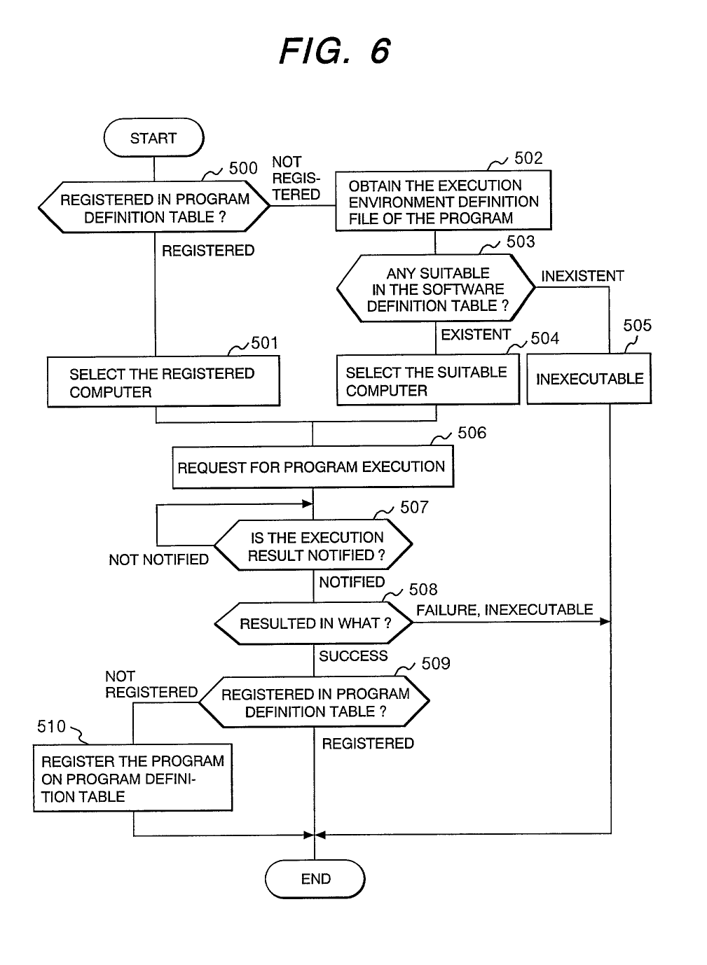

FIG. 6 is a flowchart indicating flows of processing in the execution environment-selecting unit 111 and the execution-requesting unit 112 when a program is executed. It is assumed that a program 131 is to be executed. In advance, the execution environment selecting unit 111 searches the program definition table 150 to determine whether or not the program to be executed has been registered to this table (step 500). If the program has ever been executed, its program name is registered in association with a computer name in the program definition table 150. In this case, the computer in which the program name is registered is selected (step 501).

If the program 131 to be executed has not been registered in the program definition table 150, the execution environment definition file 132 associated with that program 131 is obtained (step 502), and the software definition table 140 is searched for a computer which meets the requirement described in the execution environment definition file 132 (step 503). If no computers meet the requirement, that is, include the required execution environment, processing is terminated by judging the execution impossible (step 505). If such a computer exists, that computer is selected (step 504). If more than one computers meet the requirement, one of them, the first found one for example, is arbitrarily selected. The execution-requesting unit 112 makes a request to the selected computer for execution (step 506) and waits until an execution result is reported from the requested computer (step 507). The execution environment-selecting unit 111 can receive the program execution result from the execution-requesting unit 112. After the execution result is received, the execution environment selecting unit 111 judges the execution result (step 508). If the execution result is “success”, the program name of the program, in association with the computer name of the computer selected for the program, is registered to the program definition table 150 (step 510) before processing is terminated unless it is judged that the program was judged in step 500 as already registered (step 509 not registered). If the execution result is judged “failure” or “inexecutable” in step 508 or if it is judged in step 509 that the program was judged as already registered, processing is terminated without registration.

Explained below are example flows of processing which would occur in FIG. 1 if the computer 110A tries to execute the program 131B prepared for the computer 110B. Assume that nothing is registered to the program definition table 150 and the software definition table 140 is written as shown in FIG. 2. First, the computer 110A make a judgement on whether the program 131B has been registered to the program definition table 150. Since not registered, the computer 110A reads in the execution environment definition file 132B, searches the software definition table 140 and finds the computer 110B provided with the architecture ARCH-B, the operating system OS-B and the software SOFT-B1. Then, the execution-requesting unit 112 makes a request to the program execution unit 113 of the computer 110B for execution via the network 160. The program execution unit 113 of the computer 110B executes the program 131B and reports the execution result to the computer 110A. The execution-requesting unit 112 of the computer 110A receives the execution result and passes it to the execution environment-selecting unit 111. If the execution result is “success”, the program 131B is registered to the program definition table 150. If the execution result is “failure”, the program 131B is not registered. As a result of the computer 110A having requested the computer 110B to execute the program 131B, the program 131B is registered to the program definition table 150 as shown in FIG. 3 if the execution result is “success”. Note that the present invention can be implemented without the program definition table 150 although the program definition table 150, if provided, sometimes allows the processing in steps 502 and 503 to be bypassed.

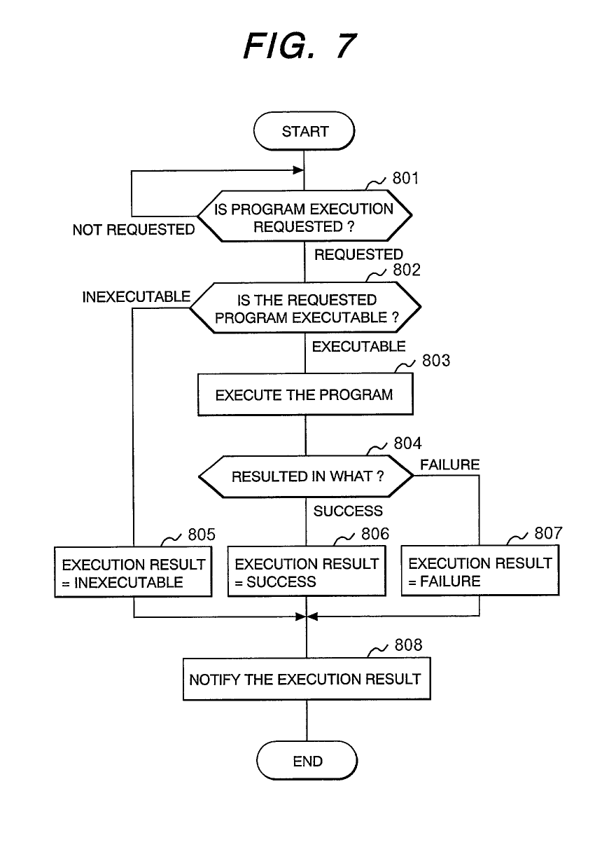

FIG. 7 is a flowchart indicating flows of processing in the program execution unit 113. First, the program execution unit 113 waits an execution request from either computer (step 801). If an execution request is received, the program execution unit 113 determines whether or not the specified program is executable by examining the restrictions concerning the access from the actual execution computer to the program to be executed, such as whether the computer is authorized to execute the program (step 802). If the program is judged inexecutable in step 802, “inexecutable” is set to “execution result” (step 805). If the program is judged executable, the specified program is executed (step 803). Then, if the execution result is a success (step 804), “success” is set to “execution result” (step 806). If the execution result is a failure, “failure” is set to “execution result” (step 807). Then, the execution result is reported to the computer which has issued the execution request (step 808).

Thus, although the program 131B is dependent on the computer 110B, the above described processing procedure between the computer 110A and the computer 110B allows the user to have the computer 110B execute the program 131B via the computer 110A with the computer being transparent to the user. Opposite to this procedure, it is also possible to have the computer 110A execute a program from the computer 110B.

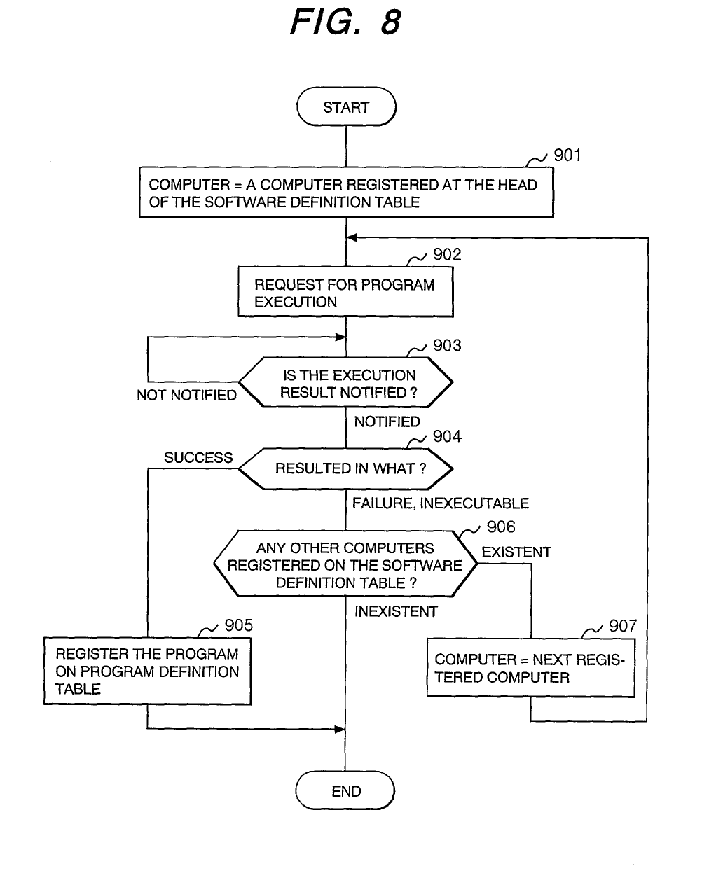

In the examples shown above, it is assumed that the execution environment definition file 132 has been registered. Referring to FIG. 8, a description will be made of the processing procedures that would be followed by the execution environment-selecting unit 111 and the execution-requesting unit 112 when the execution environment definition file 132 has not been registered for the program to be executed. In this case, if the program is judged as not registered to the program definition table 150 in step 500, the execution environment-selecting unit 111 selects a computer registered at the top of the software definition table 140 (step 901) instead of performing steps 502 and 503. Then the execution requesting unit 112 requests the selected computer to execute the program (step 902) and waits until the execution result is reported (step 903). Upon receiving the execution result, the execution requesting unit 112 judges the execution result (step 904). If the execution result is “success”, the program name in association with the computer name is registered to the program definition table 150 (step 905) before processing is terminated. If the execution result is “failure” or “inexecutable”, the software definition table 140 is searched for another registered computer (step 906). If more than one such computers are found there, the execution environment-selecting unit 111 selects a computer which is immediately preceded by the current selected computer in the software definition table 140 (step 907). Then the execution request unit 112 goes back to step 902 to issue an execution request again. If another registered computer is not left in the software definition table 140, processing is terminated. Practically, if the execution environment of the computer 110A is as defined by the software definition table 140 in FIG. 2 and no execution environment definition file is registered for the program to be executed, the computer 110A tries to execute the program at first. In this case, if the execution succeeds, the association is registered to the program definition table 150. If the execution fails, the computer 110B tries next and, if the execution succeeds, the association is registered to the program definition table 150. In the subsequent execution of the program, the computer which succeeded in executing the program will be selected by referring to the program definition table 150.

Now how each processing unit starts its execution will be described. The computer 110 activates the software information registering unit 114 and the software information collecting unit 115, and they are executed when that computer is initially connected to the magnetic disk device 130. The program execution unit 113 is always in a state of activation in the computer 110 to await an execution request. The execution environment selecting unit 111 and the execution requesting unit 112 are activated when a user starts executing a program. Therefore, they have an interface to the user.

The way of implementation of the execution environment selecting unit 111 and the execution requesting unit 112 depends on the type of the computer 110. For example, a command is provided for the user in the open system computer which executes a program through command lines, while a program driven by a job control language is provided for the user in the main frame computer which executes a program in a frame of a batch job.

Following are the exemplary procedures to execute the relevant programs in both an open system and a main frame system.

| | |
|---|---|
| Open system: | $ runprogu /tmp/exea |
| main frame system: | // job name JOB |
| | // step name EXEC RUNPROGM |
| | /SYSIN DD * |
| | SYSTEM(JOB) |
| | /* |

As a result of the program execution, the execution environment selecting unit 111 and the execution requesting unit 112 execute their processing as shown in step 500˜510 and step 901˜907. Note that the program is implemented in a form of runprogu command for the open system while it is implemented in a form of RUNPROGM described in the EXEC statement. The runprogu command allows the user to specify a user program to be executed as a parameter. In this example, /tmp/exea is a name of the user program. In RUNPROGM, the user program to be executed is read in through the SYSIN statement. In this example, SYSTEM(JOB) is a name of the user program.

Note that preparing a script file allows the user to repeatedly execute a series of commands from that script file. In addition, the job control languge enables the user to describe a plurality of jobs as a single job. Therefore, both a program executed by a computer and another program executed by another computer can be executed by means of a single script file or a single job definition. Accordingly, the processing procedures over a plurality of computers can be easily prepared.

The method explained so far allows a program to be executed in a multi-computer system with the computer that executes the program being transparent to the user. Although the embodiment of the present invention explained so far uses a network to connect the computer 110A and the computer 110B, computer to computer communication may also be implemented by other means such as disk share and memory share. Also the present invention may be implemented without any trouble even when each of the computers 110A and 110B is a logical computer although a control program is necessary instead of the network 160 in order to control communications between the logical computers. Also although programs are respectively associated with the corresponding execution environment definition files by means of naming of the files in the embodiment of the present invention, other methods can also be used for association.

According to the present invention as described so far, the user in a multi-computer system composed of a plurality of computers can execute and control programs which are respectively dependent on the environments of some computers in the multi-computer environment with the computer that executes these programs being transparent to the user. In addition, according to the present invention, the user can prepare and manage programs in the same manner as in a single-computer system since each program is executed by an automatically selected appropriate computer whose execution environment affords to execute the program.

What is claimed is:

1. A method for executing a program in a multi-computer environment composed of a plurality of computers where the program is dependent on at least one of said computers, comprising the steps of:
referring to a first storage means where software information defining an execution environment needed to execute respective program is stored, and acquiring corresponding software information;
selecting, by referring to a second storage means where software information defining an execution environment of each of said computers is stored, a computer which has a software information containing the acquired software information; and
requesting the selected computer to execute the program for execution, and executing the program for execution by said selected computer.

2. A method for executing a program in a multi-computer environment according to claim 1 wherein said computers are logical computers.

3. A method for executing a program in a multi-computer environment according to claim 1, further comprising the steps of:
registering an identifier of said program which has been executed to a third storage means in association with an identifier of said computer selected for said program; and
referring to said third storage means to know the identifier of the program for execution has already been registered there in association with the identifier of a computer before acquiring said software information, and if the identifier has been registered, requesting the registered computer to execute said program.

4. A method for executing a program in a multi-computer environment according to claim 1 wherein said software information stored in said first storage means has a file name configuration associated with a name of said program.

5. A method for executing a program in a multi-computer environment composed of a plurality of computers where the program is dependent on at least one of said computers, comprising the steps of:
referring to a storage means where an identifier of a program for execution is stored in association with an identifier of a computer which is capable of executing the program for execution, and if the identifier of the computer has already been registered in association with the identifier of the program for execution, requesting the registered computer to execute said program;
if the identifier of the computer is not registered in association with the identifier of the program for execution, requesting any one of said computers to execute said program;
registering the identifier of said program to said storage means in association with the identifier of the requested computer if it is reported from the requested computer that the execution has succeeded; and
requesting another computer to execute said program if it is reported from the requested computer that the execution has not succeeded.

6. An execution control program for controlling the execution of a program in a multi-computer environment composed of a plurality of computers where the program to be executed is dependent on at least one of said computers, said execution control program allowing a computer to execute:
a step of referring to a first storage means where software information defining an execution environment needed to execute respective program is stored, and acquiring corresponding software information;
a step of selecting, by referring to a second storage means where software information defining an execution environment of each of said computers is stored, a computer which has a software information containing the acquired software information; and
a step of requesting the selected computer to execute the program for execution.

7. An execution control program according to claim 6 wherein said computers are logical computers.

8. An execution control program according to claim 6, further allowing a computer to execute:
a step of registering an identifier of said program which has been executed to a third storage means in association with an identifier of said computer selected for said program; and
a step of referring to said third storage means to know the identifier of the program to be executed has already been registered there in association with the identifier of a computer before acquiring said software information, and if the identifier has been registered, requesting the registered computer to execute said program.

9. An execution control program according to claim 6 wherein said software information stored in said first storage means has a file name configuration associated with a name of said program.

10. An execution control program for controlling the execution of a program in a multi-computer environment composed of a plurality of computers where the program to be executed is dependent on at least one of said computers, said execution control program allowing a computer to execute:
a step of referring to a storage means where an identifier of a program is stored in association with an identifier of a computer which is capable of executing the program, and if the identifier of the computer has already been registered in association with the identifier of the program for execution, requesting the registered computer to execute said program;
a step of requesting any one of said computers to execute said program if the identifier of any computer is not registered in association with the identifier of the program for execution;
a step of registering the identifier of said program to said storage means in association with the identifier of the requested computer if it is reported from the requested computer that the execution has succeeded; and
a step of requesting another computer to execute said program if it is reported from the requested computer that the execution has not succeeded.
